(19) United States
(12) Patent Application Publication
(10) Pub. No.: US 2026/0073543 A1
(43) Pub. Date: Mar. 12, 2026

(54) STEREO DEPTH ESTIMATION UTILIZING ASYMMETRIC DOWNSAMPLING IN DIFFERENT DIRECTIONS

(71) Applicant: QUALCOMM Incorporated, San Diego, CA (US)

(72) Inventor: Jamie Menjay LIN, San Diego, CA (US)

(21) Appl. No.: 18/882,473

(22) Filed: Sep. 11, 2024

(51) Int. Cl. G06T 7/593; G06T 3/40; H04N 13/00; H04N 13/156; H04N 13/239

(52) U.S. Cl. CPC G06T 7/593; G06T 3/40; H04N 13/156; H04N 13/239; G06T 2207/20084; H04N 2013/0081

(57) ABSTRACT

Aspects relate to stereo depth estimation utilizing asymmetric down-sampling in different directions. A device may include one or more memories configured to store a plurality of images and a plurality of cameras. The plurality of cameras may be configured to capture a left and right image, in which, each of the images includes one or more patches, each patch including plurality of pixels. The device may include one or more processors coupled to one or more memories, in which, the one or more processors are configured to: down-sample in a first direction on a first set of pixels in a first patch of a first image to generate a first down-sample; and down-sample in a second direction on a second set of pixels in a second patch of a second image to generate a second down-sample, the second down-sample including a greater number of pixels.

### TECHNICAL FIELD

The technology discussed below relates generally to down-sampling, and more particularly, to down-sampling in different directions.

### INTRODUCTION

Stereo vision may be defined as the ability to perceive depth and spatial information by using two images of the same scene from slightly different perspectives. It is based on the idea that humans have two eyes that see the world from slightly different positions, and the brain combines these views to create a three-dimensional sensation. Stereo video or pictures may be achieved using two views, e.g., a left view and a right view. In order to simulate a human vision system, which has depth perception, a device with two camera sensors may capture left eye and right eye views. However, in stereo vision, there is disparity in the distance between corresponding points in the two images taken from the slightly different positions of the two sensors having left and right views. Stereo depth estimation is utilized to calculate the disparity between two images taken from slightly different points. Disparity is the distance between corresponding pixel points in the left and right images. Once the disparity is calculated, the depth can be estimated.

In order to implement computer vision for a computing device, tasks are typically implemented that go through an encoder-decoder model architecture, where the encoder takes the raw image input and performs feature extraction through multiple stages of pyramid levels. However, as to stereo depth estimation, the common practice for the encoder to perform feature extraction by down-sampling feature maps at multiple pyramid levels has been found to lead to major losses in model accuracy. In particular, the encoder down-sampling the feature maps also forces the encoded feature maps to lose critical details leading to loss in depth estimation accuracy. Another issue that arises in down-sampling is that the reduction in computational complexity lowers accuracy and resolution. While desirably achieving reduced complexity in computation and/or memory, reduced resolution inevitably involves reduced accuracy. Reduced resolution can often cause damage to model accuracy as the hypotheses for the disparity estimation can also be significantly reduced along with the resolution reduction.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a device is provided. The device may include one or more memories configured to store a plurality of images and a plurality of cameras. The plurality of cameras may be configured to capture a left and right image, in which, each of the images includes one or more patches, each patch including plurality of pixels. The device may further include one or more processors coupled to one or memories, in which, the one or more processors are configured to: down-sample in a first direction on a first set of pixels in a first patch of a first image to generate a first down-sample; and down-sample in a second direction on a second set of pixels in a second patch of a second image to generate a second down-sample, in which, the second down-sample includes a greater number of pixels.

Another example provides a method for providing a stereo image. The method includes: capturing one or more images, in which, each of the images includes one or more patches, each patch including plurality of pixels. The method further includes: down-sampling in a first direction on a first set of pixels in a first patch of a first image to generate a first down-sample; and down-sampling in a second direction on a second set of pixels in a second patch of a second image to generate a second down-sample, in which, the second down-sample includes a greater number of pixels.

In yet another example, a non-transitory computer-readable data storage medium is provided that has stored thereon instructions that, when executed, cause one or more processors to: capture one or more images, in which, each of the images includes one or more patches, each patch including plurality of pixels; down-sample in a first direction on a first set of pixels in a first patch of a first image to generate a first down-sample; and down-sample in a second direction on a second set of pixels in a second patch of a second image to generate a second down-sample, in which, the second down-sample includes a greater number of pixels.

These and other aspects will become more fully understood upon a review of the detailed description, which follows. Other aspects, features, and examples will become apparent to those of ordinary skill in the art, upon reviewing the following description of examples in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary examples may be discussed below as device, system, or method examples such exemplary examples can be implemented in various devices.

### BRIEF DESCRIPTION OF THE DRAWINGS

FIG. 1 is a diagram illustrating an example of a device according to some aspects.

FIG. 2 is a diagram illustrating an example of a world point P(X,Y,Z), a left image plane of the left camera, and a right image plane of the right camera according to some aspects.

FIG. 3 is a diagram illustrating an example of disparities between pixels on the left and right image planes according to some aspects.

FIG. 4 is a flowchart illustrating an example operation for down-sampling according to some aspects.

FIG. 5 is a diagram illustrating an example operation for down-sampling images according to some aspects.

FIG. 6A is a diagram illustrating down-sampling utilizing multiple-aspect ratios according to some aspects.

FIG. 6B is a diagram illustrating down-sampling and up-sampling utilizing multiple-aspect ratios according to some aspects.

FIG. 7 is a diagram illustrating asymmetric S2D operations for down-sampling and asymmetric D2S for up-sampling according to some aspects.

FIG. 8 illustrates a proof-of-concept of the techniques of the disclosure related to encoding and decoding for stereo depth estimation utilizing asymmetric operations according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

As will be described, aspects of the disclosure generally relate to down-sampling, and more particularly, to down-sampling in different directions. In one example aspect, down-sampling for stereo depth estimation may be implemented using asymmetric operations in width and height. As will be described, a device may include one or more memories configured to store a plurality of images and a plurality of cameras. The plurality of cameras may be configured to capture a left and right image, in which, each of the images includes one or more patches, each patch including plurality of pixels. The device may further include one or more processors coupled to one or more memories, in which, the one or more processors are configured to: down-sample in a first direction on a first set of pixels in a first patch of a first image to generate a first down-sample; and down-sample in a second direction on a second set of pixels in a second patch of a second image to generate a second down-sample, in which, the second down-sample includes a greater number of pixels.

In one example, the first down-sample in the first direction may be in height and the second down-sample in the second direction may be in width, such that, the first and second down-sample is an asymmetric down-sample operation that includes a higher resolution in width. Therefore, in one example, the left camera is configured to capture the left image and the right camera is configured to capture the right image, and the one or the processors are configured to generate both the first and second down-samples in both height and width for each of the left and right images, respectively. In this way, the device may be configured to implement asymmetric operations for the width and height of the image captured by the plurality of cameras during down-sampling operations, in which, the asymmetric operations include higher resolution in width. Based upon the asymmetric operations, stereo vision of the image may be provided. Utilizing these techniques, stereo vision is provided that preserves disparity and enhanced resolution, while still being performed in an efficient manner.

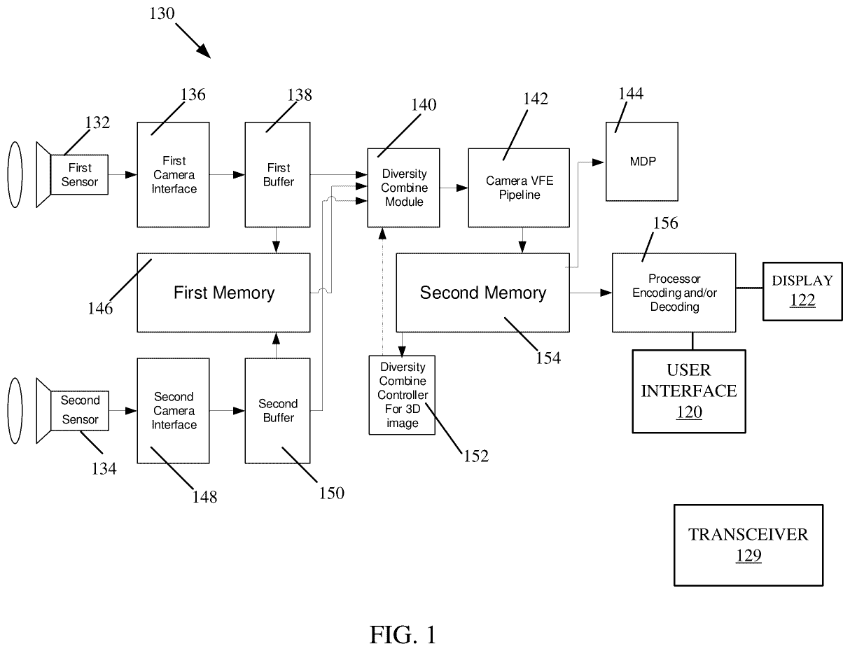

FIG. 1 illustrates a device 130 with dual digital sensors 132, 134 configured to capture and process 3-D stereo images and videos. It should be appreciated that digital sensors 132,134 may be camera sensors but that other sorts of sensors may be utilized. Also, device 130 may be a mobile device but also may be a fixed device or another sort of device. In general, device 130 may be configured to capture, create, process, modify, scale, encode, decode, transmit, store, and display digital images and/or video sequences. Device 130 may provide high-quality stereo image capturing, various sensor locations, view angle mismatch compensation, and an efficient solution to process and combine a stereo image.

Additionally device 130 may represent or be implemented in a wireless communication device, a personal digital assistant (PDA), a handheld device, a laptop computer, a desktop computer, a digital camera, a digital recording device, a network-enabled digital television, a mobile phone, a cellular phone, a satellite telephone, a camera phone, a terrestrial-based radiotelephone, a direct two-way communication device (sometimes referred to as a “walkie-talkie”), a camcorder, etc.

Device 130 may include a first sensor 132, a second sensor 134, a first camera interface 136, a second camera interface 148, a first buffer 138, a second buffer 150, a memory 146, a diversity combine module 140 (or engine), a camera process pipeline 142, a second memory 154, a diversity combine controller for 3-D image 152, a mobile display processor (MDP) 144, a processor 156, a user interface 120, a display device 122, and a transceiver or modem 129. In addition to or instead of the components shown in FIG. 1, the mobile device 130 may include other components. The architecture in FIG. 1 is merely an example. The features and techniques described herein may be implemented with a variety of other architectures. As will be described, processor 156 may include one or more processors and may implement down-sampling/encoding functions and/or up-sampling/decoding functions.

The sensors 132, 134 may be digital camera sensors. The sensors 132, 134 may have similar or different physical structures. The sensors 132, 134 may have similar or different configured settings. The sensors 132, 134 may capture still image snapshots and/or video sequences. Each sensor may include color filter arrays (CFAs) arranged on a surface of individual sensors or sensor elements.

The memories 146, 154 may be separate or integrated. The memories 146, 154 may store images or video sequences before and after processing. The memories 146, 154 may include volatile storage and/or non-volatile storage. The memories 146, 154 may comprise any type of data storage means, such as dynamic random access memory (DRAM), FLASH memory, NOR or NAND gate memory, or any other data storage technology.

The camera process pipeline 142 (also called engine, module, processing unit, video front end (VFE), etc.) may comprise a chip set for a mobile phone, which may include hardware, software, firmware, and/or one or more microprocessors, digital signal processors (DSPs), application specific integrated circuits (ASICs), field programmable gate arrays (FPGAs), or various combinations thereof. The pipeline 142 may perform one or more image processing techniques to improve quality of an image and/or video sequence.

Processor 156 may include one or more processors and may implement down-sampling/encoding functions and/or up-sampling/decoding functions. Processor 156 may also implement other functions of device 130. Processor 156 may operate as a video encoder and may implement or comprise an encoder/decoder (CODEC) for encoding (or down-sample or compress, etc.) and decoding (or up-sample or decompress) digital video data. As an example, the processor operating to implement video encoder function may use one or more encoding/decoding standards or formats, such as MPEG or H.264. In other examples, separate video encoder and/or video decoder devices may be utilized.

The transceiver or modem 129 may receive and/or transmit coded images or video sequences to another device or a network. The transceiver or modem 129 may use a wireless communication standard, such as code division multiple access (CDMA). Examples of CDMA standards include CDMA 1× Evolution Data Optimized (EV-DO) (3GPP2), Wideband CDMA (WCDMA) (3GPP), etc. In other examples, transceiver or modem 129 may utilize other cellular communication standards, such as 4G, 4G-LTE (Long-Term Evolution), LTE Advanced, 5G, 6G, or the like. In some examples, other wireless standards, such as IEEE 802.11 specification, IEEE 802.15 specification (e.g., ZigBee™), Bluetooth™ standard, or the like, may be utilized.

Device 130 may maintain a fixed horizontal distance between the two sensors 138, 150 such that 3-D stereo image and video can be generated efficiently. As shown in FIG. 1, the two sensors 132, 134 may be separated by a suitable fixed horizontal distance. The first sensor 132 may be a primary sensor, and the second sensor 134 may be a secondary sensor. The second sensor 134 may be shut off for non-stereo mode to reduce power consumption. However, this is an optional sensor set-up.

The two buffers 138, 150 may store real time sensor input data, such as one row or line of pixel data from the two sensors 132, 134. Sensor pixel data may enter the small buffers 138, 150 on-line (i.e., in real time) and be processed by the diversity combine module 140 and/or camera engine pipeline engine 142 offline with switching between the sensors 132, 134 (or buffers 138, 150) back and forth. The diversity combine module 140 and/or camera engine pipeline engine 142 may operate at about two times the speed of one sensor's data rate. To reduce output data bandwidth and memory requirement, stereo image and video may be composed in the camera engine 142.

The diversity combine module 140 may first select data from the first buffer 138. At the end of one row of buffer 138, the diversity combine module 140 may switch to the second buffer 150 to obtain data from the second sensor 134. The diversity combine module 140 may switch back to the first buffer 138 at the end of one row of data from the second buffer 150.

In order to reduce processing power and data traffic bandwidth, the sensor image data in video mode may be sent directly through the buffers 138, 150 (bypassing the first memory 146) to the diversity combine module 140. On the other hand, for a snapshot (image) processing mode, the sensor data may be saved in the memory 146 for offline processing. In addition, for low power consumption profiles, the second sensor 134 may be turned off, and the camera pipeline driven clock may be reduced.

Aspects of the disclosure generally relate to down-sampling, and more particularly, to down-sampling in different directions. As will be described, aspects of the disclosure relate to down-sampling for stereo depth estimation utilizing asymmetric operations in different directions (e.g., in width and height). As shown in FIG. 1, device 130 may include one or more memories 146, 154 that are configured to store a plurality of images from cameras 132, 134. Cameras 132,134 may be configured to capture a left and right image, respectively, in which, each of the images includes one or more patches, each patch including plurality of pixels. Device 130 may further include one or more processors 156 that are coupled to the memories. Processor 156 may be configured to: down-sample in a first direction on a first set of pixels in a first patch of a first image to generate a first down-sample; and down-sample in a second direction on a second set of pixels in a second patch of a second image to generate a second down-sample, in which, the second down-sample includes a greater number of pixels. As has been described, processor 156 may implement the functions of an encoder and/or decoder or separate encoders and/or decoders may be utilized on the same device or different devices.

In one example, as be described in more detail hereafter, the first down-sample in the first direction is in height and the second down-sample in the second direction is in width, such that, the first and second down-sample is an asymmetric down-sample operation that includes a higher resolution in width.

Therefore, in one example, the left camera 132 is configured to capture the left image and the right camera 134 is configured to capture the right image, and the one or the processors 156 are configured to generate both the first and second down-samples in both height and width from each of the left and right images, respectively. In this way, device 130 may be configured to implement asymmetric operations for the width and height of the image captured by the plurality of cameras 132, 134 during down-sampling operations, in which, the asymmetric operations include higher resolution in width. Based upon the asymmetric operations, stereo vision of the image may be provided. Utilizing these techniques, stereo vision is provided that preserves disparity and enhanced resolution, while still being performed in an efficient manner. For example, stereo vision of the image may be displayed on a display device 122. In particular, by utilizing these techniques, stereo vision is provided that preserves disparity and enhanced resolution, by focusing more on width than height, while being done in a more efficient computational manner, which results in less computational tasks and less power than the conventional processes. It should be appreciated that terminology down-sampling and encoding and up-sampling and decoding are used interchangeably throughout the disclosure.

Aspects of the disclosure relate to a device or system that provides multi-aspect-ratio implementation in down-sampling for stereo disparity estimation. For example, multi-aspect-ratio down-sampling for stereo depth is presented that provides for disparity preservation and width-centric processing for disparity handling. Further, as will be described, asymmetric space-to-depth encoding and depth-to-space decoding is provided for disparity estimation. For example, disparate-rate height-width space-to-depth encoding and disparate-rate height-width depth-to-space encoding will be described.

It should be appreciated that system or device 130 is merely an example. Further, as has been described, processor 156 may implement the functions of an encoder and/or decoder or separate encoders and/or decoders may be utilized on the same device or different devices.

In one aspect, to address problems associated with the previously described common practice of an encoder performing feature extraction by down-sampling feature maps that results in the loss of critical details and depth estimation accuracy, aspects of the disclosure provide embodiments related to multi-aspect-ratio down-sampling for stereo depth that provide for disparity preservation and width-centric processing for disparity preservation. The multi-aspect-ratio down-sampling for stereo depth and width-centric processing methods to be described estimate pixel-wise disparities between rectified stereo images in a manner that provides for disparity preservation. In one aspect, the disparity information per-pixel is carried by stereo inputs. As one example, processor 156 may operate as a feature extractor and/or encoder for down-sampling and may implement a machine-learning (ML) module to implicitly carry the disparity information.

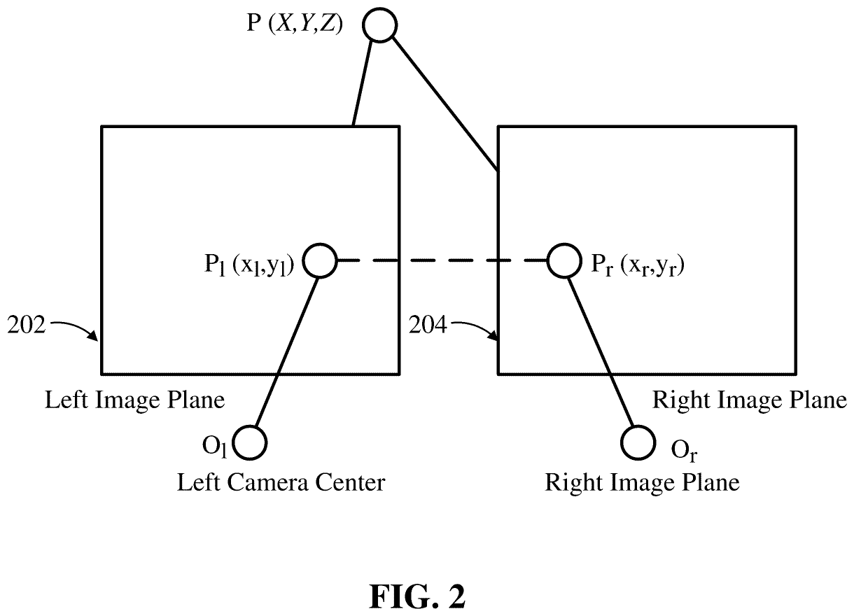

As an example of implementation, with reference to FIG. 2, a world point P(X,Y,Z), a left image plane 202 of the left camera, and a right image plane 204 of the right camera are shown. Further, the left camera center Oₗ and right center camera Oᵣ are shown. Based upon these points, pₗ (xₗ,yₗ) and pᵣ (xᵣ,yᵣ) on the left image plane and the right image plane are shown, respectively. It should be noted that in this horizontally rectified stereo set-up, the disparity information is carried between the stereo images for the world point P, which is projected on the stereo left and right images 202 and 204. In particular, the width disparity may be considered to be xᵣ−xₗ.

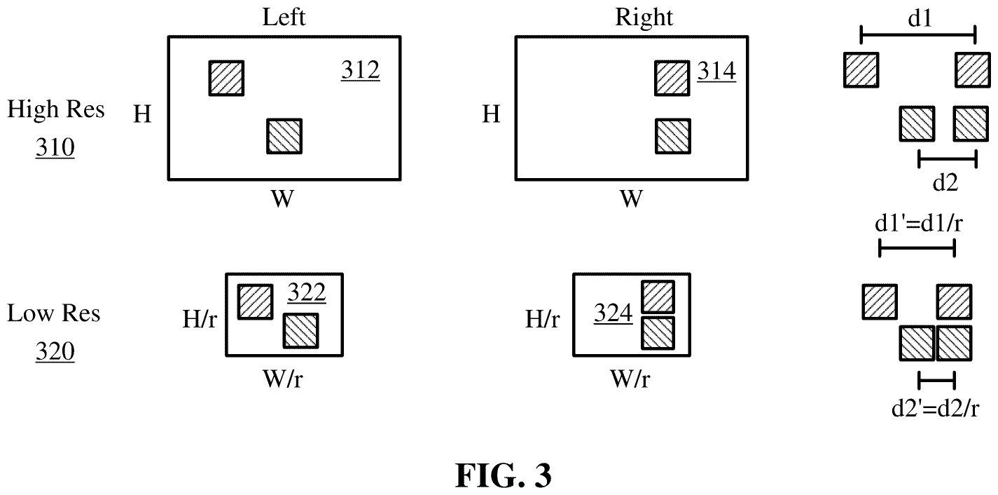

With additional reference to FIG. 3, FIG. 3 illustrates disparities between pixels on the left and right image planes. As can be seen in FIG. 3, with respect to a top high resolution example 310, a left and right image plane 312 and 314 are shown, each having top and bottom pixels (the left and right image planes, having a y-axis in height (H) and x-axis in width (W)). In particular, as shown, the disparities between the top and bottom pixels on the left image plane 312 and the right image plane 314 are shown as d1 and d2. The disparities may be considered equivalent to xᵣ−xₗ, as previously described (e.g., in the width dimension).

Now considering the effect of the image down-sizing by a factor of r (e.g., r=2, 4, 8, etc.) a lower resolution example 320 is shown, again with a left and right image plane 322 and 324, each having top and bottom pixels (the left and right image planes, having a y-axis in height (H/r) and x-axis in width (W/r)). As can be seen in this example, the down-sized (e.g., lower resolution) images are now shown with reduced disparities of d1′=d1/r and d2′=d2/r, which are down-scaled by a factor of r. Accordingly, the model accuracy of disparity estimation is directly affected in width (e.g., horizontally), whereas height has not been found to be as an important of a factor. The utility of this disparity hypothesis will be further described hereafter in detail.

According to aspects of the disclosure, a technique for stereo depth estimation, in which, the disparity information as carried in the pixel-wise distance between the left and right image pairs (e.g., as previously shown in FIG. 3) and the encoded latent left and right (L and R) features is preserved. Further, convolution networks (e.g., neural networks) can further utilize these down-sized input images and latency encoded feature maps. It has been found in prior art implementations, that downsizing equally in height and width results in poor disparity estimation, whereas, aspects of the disclosure provide an approach to utilizing disparate down-sampling between height and width by keeping higher resolution in width (than in height) to better preserve disparity insight for stereo depth estimation.

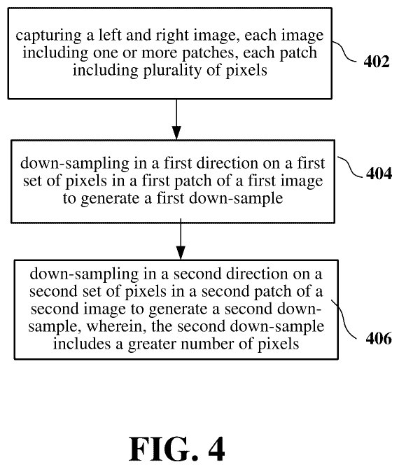

With reference to FIG. 4, FIG. 4 is a flowchart illustrating down-sampling, in accordance with one or more techniques of this disclosure. At block 402, one or more images are captured, in which each of the images includes one or more patches, each patch including a plurality of pixels. At block 404, down-sampling occurs in a first direction on a first set of pixels in a first patch of a first image to generate a first down-sample. At block 406, down-sampling occurs in a second direction on a second set of pixels in a second patch of a second image to generate a second down-sample, wherein, the second down-sample includes a greater number of pixels.

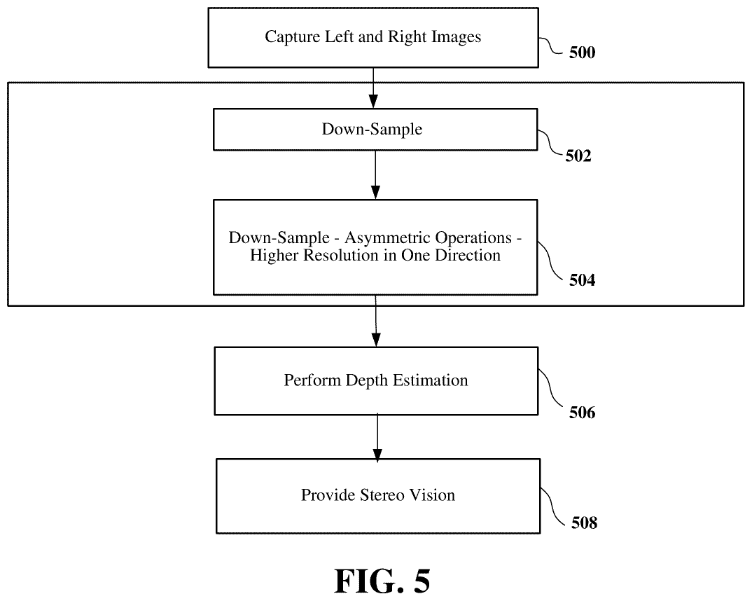

With reference to FIG. 5, FIG. 5 is a diagram illustrating an example operation for down-sampling images, in accordance with one or more techniques of this disclosure. The operations presented in the flowcharts of this disclosure are provided merely as examples. At block 500, left and right images are captured from left and right cameras (e.g., cameras 132 and 134). At block 502, down-sampling occurs. As an example of down-sampling, down-sampling may occur asymmetrically with higher resolution in one direction (block 504). As has been previously described, in one aspect, down-sampling occurs in a horizontal directional on a first set of pixels on each of the left and right images to generate a horizontal down-sample, and, down-sampling occurs in a width direction on a second set of pixels on each of the left and right images to generate a width down-sample, in which, the width down-sample includes a greater number of pixels. In this way, the down-sampling is any asymmetric down-sample operation that includes a higher resolution in width. Stereo depth estimation may then be performed based upon the down-sampling operation (block 506), as will be described in more detail hereafter.

Further, as an example, processor 156 may render the output of the down-sampling for the left and right images and combine the left and right rendered images to generate a stereo image that is displayed on a display device 122 (block 508), as will be described in more detail hereafter.

Therefore, down-sampling operations may be performed that are asymmetric (e.g., they may include higher resolution in width). In one example aspect, multiple asymmetric down-sample operations may be performed, in which, each asymmetric down-sample operation includes a pre-determined width-to-heigh aspect ratio.

In one example aspect, assuming the aspect ratio to a processing operation i is denoted as

$${γ}_{i} = \frac{{w}_{i}}{{h}_{i}} ,$$

i=1, 2, . . . , N among a total of N operations of the model starting with i=1 for the first model operation in training or inference by a processor (e.g., processor 156 implementing a ML neural network), where hᵢ and wᵢ are the height and width for operation i, then the model architecture may include the property of multiple-aspect ratios for encoding and decoding features:
γᵢ≤γⱼ for i<j during encoding (down-sampling stages) among {1, 2, . . . , N}, and
γᵢ≥γⱼ for i<j during decoding (up-sampling stages) among {1, 2, . . . , N}.

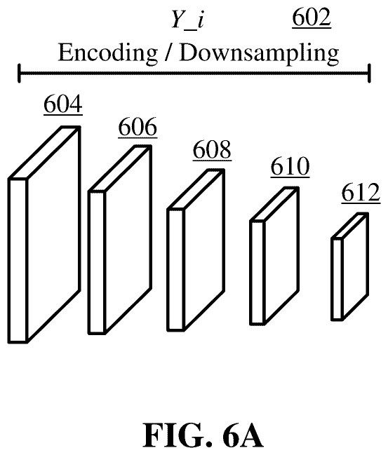

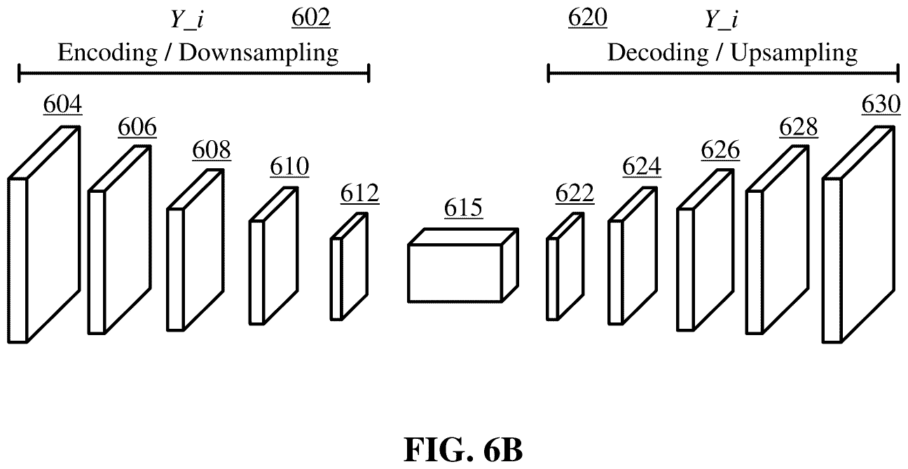

With reference to FIG. 6A, FIG. 6A is a diagram illustrating encoding/down-sampling utilizing multiple-aspect ratios. As will be described in FIG. 6B, mirrored decoding/up-sampling will also be shown. As shown in FIG. 6A, encoding/down-sampling 602 illustrates encoding/down-sampling of image data that is down-sized by a factor of yᵢ (e.g., i=1, 2, 3, 4, 5), such that the first encoded data image block has a down-size factor of i=1 [y₁] 604 (stage 1), the second encoded image data block has down-size factor i=2 [y₂] 606 (stage 2), the third encoded image data block has down-size factor i=3 [y₃] 608 (stage 3), the fourth encoded image data block has down-size factor i=4 [y₄] 610 (stage 4), and the fifth encoded image data block has down-size factor i=5 [y₅] 612 (stage 5). Each of these image data blocks 604, 606, 608, 610, and 612 (stages 1, 2, 3, 4, 5) is down-sized with an asymmetric aspect ratio

$${γ}_{i} = \frac{{w}_{i}}{{h}_{i}} ,$$

such that, horizontal width is weighted with more importance than height.

In this example of the encoding/down-sampling 602, assuming the aspect ratio to this processing operation is set in a processing encoder (e.g., implementing a ML neural network (e.g., implemented by processor 156 or a particular encoder)), in which the aspect ratio, is defined as denoted as

$${γ}_{i} = \frac{{w}_{i}}{{h}_{i}} ,$$

i=1, 2, . . . , N among a total of N operations (e.g. N=5) of the model starting with i=1 for the first model operation in training or inference and proceeding to i=5, where hᵢ and wᵢ are the height and width for each operation i, then the model architecture may include the property of multiple aspect ratios to encoded features-which can be seen as down-sized image data blocks 604, 606, 608, 610, and 612 (stages 1, 2, 3, 4, 5).

It should be appreciated that in prior art implementations, down-sample factors in terms of width and height are be equally-weighted in terms of height and width. An example of this would be equally down-sizing in both height and width by: ½, ¼, ⅛, etc. For example, in prior down-sampling implementations R_h=R_w in each stage of down-sampling. For example, going from stages: 1 à 2 à 3 à 4 à 5—the pair R_h=R_w may be (2,2) à (2,2) à (2,2) à (2,2) à (2,2). However, in the aspects of previously described disclosure,

$${γ}_{i} = \frac{{w}_{i}}{{h}_{i}} ,$$

i=1, 2, . . . , N−R_h≥R_w is implemented in each stage of down-sampling. For example, going from stages: 1 à 2 à 3 à 4 à 5 (604, 606, 608, 610, 612)—the pair (R_h, R_w) may be: (4,2) à (2,1) à (2,2) à (2,1) à (2,2). Other down-sizing implementations are also possible. However, because R_h≥R_w is held true for each of the stages, implementing 5 stages in this example (604, 606, 608, 610, and 612), resolution is preserved in the dimension of width better than in height. It should be appreciated that multiple width-to-height aspect ratios may be used during down-sampling/encoding. Also, the multiple width-to-height aspect ratios may be equal or increasing or decreasing during down-sampling/encoding operations.

With additional reference to FIG. 6B, in some example aspects, these down-sampled image data blocks 604, 606, 608, 610, and 612 can be up-sampled by an automatic decoder 615, in which, the up-sampled image data blocks are in the same feature/space domain and exactly match the down-sized image data blocks, as shown on the decoding/up-sampling side 620—as image data blocks 622, 624, 626, 628, and 630. However, the use of decoder 615 is completely optional. In general, decoded or up-sampled image data blocks 622, 624, 626, 628, and 630 that may be utilized would exactly match the corresponding down-sampled image data blocks.

By utilizing the previously described multi-aspect-ratio down-sampling implementations that focus more on width than in height for stereo depth (e.g., width-centric), pixel-wise disparities between rectified stereo images are processed in a manner that provides disparity preservation. In one aspect, the disparity information per-pixel is carried by the stereo inputs and is then down-sampled/encoded as previously illustrated. In one aspect, processor 156 may utilize an ML model to perform the previously described functions of down-sampling. Further, as example aspects, by utilizing encoder(s) that operate as ML modules the disparity information may be implicitly carried. The modules utilizing ML (e.g., encoder) can utilize learning and/or inference.

Therefore, as has been described, processor 156 may operate to perform down-sampling/encoding functions and can implement the ML functions for learning and/or inference. Also, it should be appreciated that variants in the model architecture may include multiple encoders, multiple decoders, interleaved encoder-decoder module (e.g., hour-glass modules, etc.). Further, it should be appreciated that a wide variety of neural network models, neural processors, neural hardware and/or software accelerators, etc. may be utilized. In a broad aspect, processor 156 may implement ML models during down-sampling and/or up-sampling to perform down-sampling/encoding functions and/or up-sampling/decoding functions and can implement ML functions for learning and/or inference.

In one example aspect, an up-sampling process implemented by processor 156 (or a separate decoder) may be used for stereo depth. In this case, a “coarse-to-fine” feature may be used for stereo depth as an overall algorithm to start stereo estimation at the coarse level before continuing to the next finer level. One reason for such type of stereo depth algorithm is that local minimums can be effectively removed/reduced. In this example, both down-sampling in the encoding feature and up-sampling in the coarse-to-fine stereo depth may be used in order for the overall stereo depth algorithm to properly run. Also, an up-sampling process may be used to serve two purposes: 1) to support multi-resolution stereo matching algorithm with a mixture of respective fields; and 2) to recover the estimated stereo disparity/depth map back to the original or desirable (higher) resolution. Therefore, the stereo matching algorithm may be used to leverage the coarse-to-fine resolution levels to avoid local minimums in optimization.

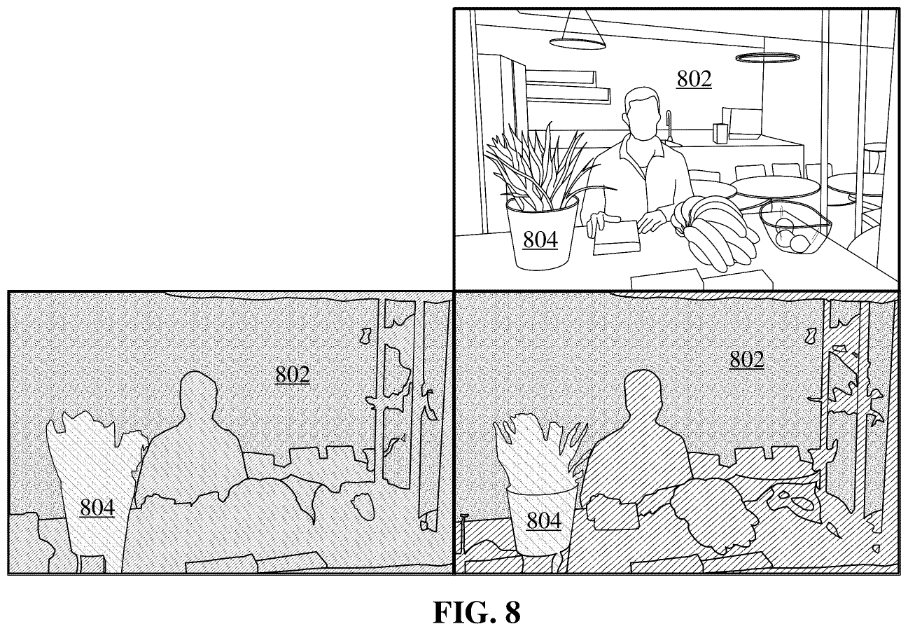

Further, additional layers of 2D convolution functions and/or 3D convolution functions may be implemented that provide spatial filtering on top of the previously described asymmetric down-sampling operations. This allows processor 156 implementing ML functions for learning and/or inference (e.g., implementing a neural network) to obtain more opportunities for learning and inference. Based upon the ML-based stereo matching algorithm and filtering functions during the down-sampling by the processor 156, the stereo image output rendered by the down-sampling process is improved and includes stereo depth map resolution that closely replicates the original stereo depth map resolution associated with the original stereo image. An example of the stereo depth map resolution will be described with reference to FIG. 8. As previously described, processor 156 of device 130 may command the display on a display device 122 of the stereo image output (as will be described with reference to FIG. 8).

In one example aspect, based upon the implementation of the ML model during the down-sampling process 602 by the processor 156, the stereo image output rendered by the down-sampling process is improved and includes stereo depth map resolution that closely replicates the original stereo depth map resolution associated with the original stereo image. An example of the stereo depth map resolution will be described with reference to FIG. 8. As previously described, processor 156 of device 130 may command the display on a display device 122 of the stereo image output (as will be described with reference to FIG. 8).

It should be appreciated that artificial intelligence (AI) functionality and machine learning (ML) functionality may be utilized in these operations for learning, inference, etc., in the encoding, decoding, and other operations. AI generally is a field of research in computer science that develops and studies methods and software that enable machines to perceive their environment and use learning and intelligence to take actions that maximize their chances of achieving defined goals, such as, making predictions, recommendations or decisions influencing real or virtual environments. In particular, AI is a set of technologies that enable computers to perform a variety of advanced functions, including the ability to see, understand and translate spoken and written language, analyze data, make recommendations, and many other functions. ML may be considered a field of study in AI concerned with the development and study of statistical algorithms that can learn from data and generalize to unseen data and thus perform tasks without explicit instructions. The term AI/ML prediction, learning, inference, etc., referred to herein, may be any type of AI and/or ML related techniques, processes, algorithms, etc., that may be utilized herein to achieve the described functions. In other aspects other techniques that are not AI and/or ML related may be utilized to achieve the described functions.

According to aspects of the disclosure, the previously described techniques for stereo depth estimation, that utilize multi-aspect-ratio down-sampling 602 implementations that focuses more on width than in height for stereo depth (e.g., width-centric) results in pixel-wise disparities between rectified stereo images being processed in a manner that provides disparity preservation. In this way, the previously described down-sampling process 602 that implements down-sampling operations provides stereo vision of images with improved disparity preservation. Also, by utilizing the previously described techniques of the disclosure, stereo vision is provided that preserves disparity and enhanced resolution, while being done in a more efficient computational manner by focusing more on width than height, which results in less computational tasks and less power than the conventional process.

In another aspect, width-centric or disparity-dimension-centric processing may be utilized in down-sampling and up-sampling operations to provide stereo vision of an image in order to provide improved disparity preservation. Width-centric or disparity-dimension-centric processing may be utilized in down-sampling and up-sampling operations to facilitate improved learning and/or inference in ML model implementations to provide improved disparity preservation. In one aspect, asymmetric operations during down-sampling and up-sampling operations to increase width dimension weighting may be utilized. In one example aspect, an asymmetric attention mechanism may be performed to focus more heavily on the width dimension. As an example type of asymmetric attention mechanism, variable width-to-height ratios for derivation of queries, keys, and/or values in favor of features in the width dimension may be utilized.

As one particular type of asymmetric operations, asymmetric tokenization rates in the width dimension may be utilized. As an example of an asymmetric operation, asymmetric operations that include the use of asymmetric patchification based upon asymmetric tokenization rates to increase width-to-height ratios of input images to allocate more patches in width than in height during asymmetric patchification may be utilized. As an example of asymmetric patchification, width-to-height ratios for 2D patches of features may be increased for encoding. For example, when provided an original R=W/H for an input, more patches may be allocated in width than in the height during patchification, such that, after patchification, the 2-D patches have an increased ratio of R′=W′/H′>R=W/H. Therefore, patchification may be utilized as a special case of tokenization for 2D inputs in computer vision.

As another type of asymmetric operation, 1-D convolution for disparity-centric processing by focusing on the width dimension may be utilized in encoding and decoding operations to provide stereo vision of an image in order to provide improved disparity preservation. As to one type of asymmetric operation, asymmetric operations may include the use of variable-rate dilation for convolution in favor of the width dimension. As an example, when provided with 2-D inputs, dilated convolution that allows for asymmetric dilation rates between width and height dimensions may be utilized in favor of the width dimension. As another type of asymmetric operation, asymmetric operations may include the use of 1-D convolution for disparity-centric processing by focusing on the disparity dimension. For example, asymmetric separable convolution may be performed over the H and W dimensions. As one example, separable ID convolutions may be performed over the H and W dimension, but with different kernel sizes in favor of the width dimension. As one particular example, Conv1D of kernel Kh in height may be performed and another Conv1D of kernel Kw in width may be performed, where Kw>Kh so that the width dimension is favored. As another type of asymmetric operation, asymmetric kernels (or asummetric strids) for convolution to favor the width dimension may be utilized in encoding and decoding operations to provide stereo vision of an image in order to provide improved disparity preservation. For example, when provided with 2D inputs, a square K×K kernel for 2-D convolution may be utilized, such as 3×3. By utilizing asymmetric kernel convolution, Kh×Kw, may be utilized, where Kw>Kh, to favor the width dimension for more kernel weights to handle more details in the width dimension.

As yet another type of asymmetric operation according to another aspect, asymmetric Space-to-Depth (S2D) and Depth-to-Space (D2S) operations may be utilized. In current S2D/D2S operations, symmetric rates for Height (H) and Width (W) are utilized. According to another aspect, asymmetric S2D operations and asymmetric D2S operations for stereo depth estimation may be utilized in encoding-decoding implementations that focus more on width than in height for stereo depth results in pixel-wise disparities between/among rectified stereo images being processed in a manner that provides disparity preservation.

As one example, asymmetric operations include the use of asymmetric S2D operations in the width dimension, in which, a smaller rate through division in the disparity width dimension is used than in other non-disparity dimensions. In particular, in order to preserve more feature information in the width dimension, a smaller rate through division in the width dimension than in the other non-disparity dimension is utilized when performing S2D operations.

As another example, asymmetric operations include the use of asymmetric D2S operations in the width dimension, in which, a larger rate through multiplication in the width dimension is used than in other non-disparity dimensions. In particular, in order to gain more feature information in the width dimension, a larger rate through multiplication in the width dimension is used than in the other non-disparity dimension.

In prior implementations, S2D operations and D2S operations were performed with symmetric rates, for down-sampling and up-sampling, in terms of [N, C, W, R].

In this implementation, N corresponds to batch, C corresponds to channel, H to height, W to width, and R to rate.

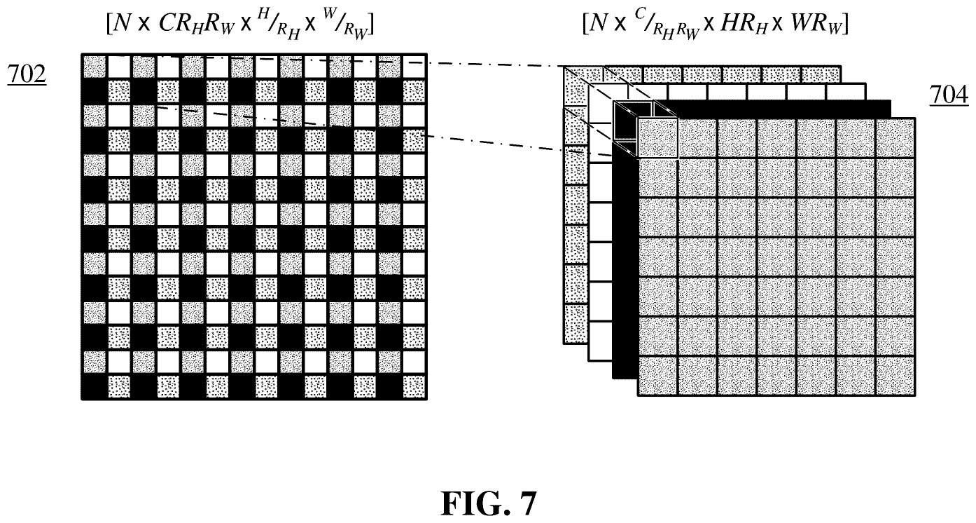

As can be seen with reference to FIG. 7, according to aspects of the disclosure, asymmetric operations include the use of asymmetric S2D operations in the width dimension for down-sampling 702 (on the left side of the FIG. 7), in which, a smaller rate through division in the disparity width dimension is used than in other non-disparity dimensions. In particular, in order to preserve more feature information in the disparity dimension, a smaller rate “R” through division in the width dimension than in the other non-disparity dimension is utilized when performing S2D operations. This functionality is implemented by features below:

$$S 2 D : [ N \times C \times H \times W ] \to [ N \times {CR}_{H} {R}_{W} \times H / {R}_{H} \times W / Rw ] {R}_{H} > Rw$$

Instead of the standard symmetric operation [N×C×H×W], an asymmetric S2D operation may be utilized where [N×CR_{H}R_{W}×H/R_{H}×W/R_{W}] for down-sampling. R_{H} may be considered a height rate factor and R_{W} may be considered a width rate factor (in which R_{H} is greater than R_{W}) such that by utilizing a smaller rate factor through division in the width dimension than in the other non-disparity dimension in this formula more features in the width disparity dimension are preserved. Therefore, at each stage of S2D down-sampling, dimensionality changes in rates of R_{H} and R_{W} may be utilized.

As can be seen with reference to FIG. 7, D2S up-sampling rates of R_{H} and R_{W} for up-sampling 704 can also be implemented, according to aspects of the disclosure, as shown on the right-side of FIG. 7. These asymmetric operations include the use of asymmetric D2S operations in the disparity dimension, in which, a larger rate through multiplication in the width dimension is used than in other non-disparity dimensions. In particular, in order to gain more feature information in the width dimension, a larger rate “R” through multiplication in the width dimension is used than in the other non-disparity dimension when performing D2S operations for up-sampling. This functionality is implemented by features below:

$$D 2 S : [ N \times C \times H \times W ] \to [ N \times C / {R}_{H} {R}_{W} \times {HR}_{H} \times W {R}_{W} ] {R}_{H} < {R}_{W}$$

In this aspect, an asymmetric D2S operation is utilized where [N×C/R_{H}R_{W}×HR_{H}×WR_{W}]. R_{H} may be considered a height rate factor and R_{W} may be considered a width rate factor (in which R_{H} is less than R_{W}) such that by utilizing a larger rate factor through multiplication in the width dimension than in the other non-disparity dimension in this formula more features in the width disparity dimension are preserved.

With brief reference to FIG. 8, FIG. 8 illustrates a proof-of-concept of the techniques of the disclosure related to down-sampling for stereo depth estimation utilizing asymmetric operations in width and height to provide a stereo view of an image that preserves disparity and enhanced resolution, while still being performed in an efficient manner.

As has been described, processor 156 may operate to perform down-sampling/encoding functions and can implement ML functions for learning and/or inference. The encoding functions are based upon the asymmetric down-sizing operations for width and height of the image data captured by the cameras 132 and 134, as previously described, in which, the asymmetric operations include higher resolution in width. Based upon these implementation features during the down-sampling process by the processor 156, the stereo image output rendered by the up-sampling process is improved and includes stereo depth map resolution that closely replicates the original stereo depth map resolution associated with the original stereo image.

An example of the stereo depth map resolution can be seen with reference to FIG. 8. As can be seen in FIG. 8, in the upper-right, an image input of a man 802 sitting at a table in front of kitchen with a plant 804 in front of him is shown. The lower left image is a disparity map generated by a conventional process with down-sampling, in which height and width dimensions are equally weighted. The lower right is a disparity map generated by the previously described techniques to implement asymmetric operations for width and height of an image during down-sampling, in which, the asymmetric operations include higher resolution in width, in which, stereo vision is provided that preserves disparity and enhanced resolution, while still being performed in an efficient manner.

As can be seen in the lower right disparity map, performed with the previously described techniques of the disclosure, the disparity information is preserved. The disparity differences between the objects of the captured image—man 802 sitting at the table in front of the kitchen with the plant 804 in front of him—can be seen between the conventional process (left-hand side) and the previously described techniques of the disclosure (right-hand side), with few differences. However, by utilizing the previously described techniques of the disclosure, stereo vision is provided with preserved disparity and enhanced resolution, while being done more efficiently with less computational tasks and less power than the conventional process.

In particular, the quality of the lower right disparity map illustrates the improved features of the disclosure that utilize the previously described multi-aspect-ratio down-sizing implementation that focuses more on width than in height for stereo depth. As has been described, the disparity information per-pixel is carried by the stereo inputs and is then down-sampled/encoded, as previously described. Further, by utilizing an encoder that utilizes ML functionality, the disparity information may be implicitly carried and encoder functions may utilize ML in learning and/or inference.

In order to support high-resolution input, down-sampling aggressively in order to meet real-time and power consumption requirements is currently needed. Aspects of the previously described disclosure describe multi-aspect ratio techniques related to down-sampling for stereo depth estimation utilizing asymmetric operations in width and height, emphasizing width, to provide a stereo view that preserves disparity and enhanced resolution, while still being performed in an efficient manner. In one aspect, asymmetric down-sampling is implemented to better preserve disparity and to avoid low resolution in the width. Asymmetric super resolution may then be utilized to return desirable output as to the original input aspect ratio. For example, down-sampling may occur to as much as 32× in the height dimension, enabling a larger respective field, while keeping the disparity dimension down at 16× or even 8×. Further, disparity can be enhanced by allocating more computational power with asymmetric encoding and asymmetric super resolution.

As has been described, the previously described techniques for stereo depth estimation that utilize multi-aspect-ratio down-sizing implementations that focus more on width than in height for stereo depth (e.g., width-centric) results in pixel-wise disparities between rectified stereo images being processed in a manner that provides disparity preservation. Further, by the implementation of ML operations for learning and/or inference in encoding/down-sampling operations, stereo depth estimation for stereo images is further improved. In this way, down-sampling operations provide stereo vision of the image with improved disparity preservation. Also, by utilizing the previously described techniques of the disclosure, stereo vision is provided that preserves disparity and enhanced resolution, while being done in a more efficient computational manner by focusing more on width than height, which results in less computational tasks and less power than the conventional process.

It should be appreciated that the features previously described for down-sampling for stereo depth estimation utilizing asymmetric operations in width and height may be utilized for a wide variety of different devices 130. In particular, these type of digital video capabilities may be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Also, such devices may implemented in scenarios related to vehicles, mobile devices, security, etc.

Various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as limitations.

The various illustrative logical blocks, modules, and circuits described in connection with the aspects disclosed herein may be implemented or performed with a general purpose processor, a DSP, an ASIC, an FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Various modifications to the described aspects may be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The processes previously described may include additional aspects, such as any single aspect or any combination of aspects described below and/or in connection with one or more other processes described elsewhere herein.

Aspect 1: A device comprising: one or more memories configured to store a plurality of images; a plurality of cameras configured to capture a left and right image, wherein each of the images includes one or more patches, each patch including plurality of pixels; and one or more processors coupled to the one or memories, the one or more processors are configured to: down-sample in a first direction on a first set of pixels in a first patch of a first image to generate a first down-sample; and down-sample in a second direction on a second set of pixels in a second patch of a second image to generate a second down-sample, wherein, the second down-sample includes a greater number of pixels.

Aspect 2: The device of aspect 1, wherein the first down-sample in the first direction is in height and the second down-sample in the second direction is in width, such that, the first and second down-sample is an asymmetric down-sample operation that includes a higher resolution in width.

Aspect 3: The device of aspect 2, wherein, multiple asymmetric down-sample operations are performed in a down-sampling process, each asymmetric down-sample operation including a width-to-height aspect ratio.

Aspect 4: The device of aspect 3, wherein the multiple width-to-height aspect ratios are equal or increasing or decreasing during the down-sampling process.

Aspect 5: The device of any aspects 1 through 4, further comprising performing depth estimation in the down-sampling process.

Aspect 6: The device of any aspects 1 through 5, wherein, the one or more processors are configured to perform an up-sampling process.

Aspect 7: The device of any aspects 1 through 6, wherein, the one or more processors are configured to: render the output of the down-sampling process for the left and right images; and combine the left and right rendered images to generate a stereo image output.

Aspect 8: The device of any aspects 1 through 7, wherein, the down-sampling process further comprises implementing a multi-aspect ratio method for estimating stereo depth.

Aspect 9: The device of any aspects 1 through 8, wherein, based upon the implementation of the multi-aspect ratio method for estimating stereo disparity in the down-sampling process, the stereo image output rendered by the down-sampling process includes stereo depth map resolution replicating original stereo depth map resolution associated with the original stereo image.

Aspect 10: The device of any aspects 1 through 9, further comprising a display device, wherein, the one or more processors are configured to command the display of the stereo image output on the display device.

Aspect 11: The device of any aspects 1 through 10, further comprising a modem configured to transmit output from the down-sampling process to another device.

Aspect 12: The device of any aspects 1 through 11, wherein, the one or more processors are further configured to: implement a machine learning model including down-sampling stages to implement the down-sampling process.

Aspect 13: The device of any aspects 1 through 12, wherein, the machine learning model is a neural network.

Aspect 14: The device of any aspects 1 through 13, wherein the asymmetric operations include the use of asymmetric space-to-depth operations in a disparity width dimension, wherein a smaller rate through division in the disparity width dimension is used than in other non-disparity dimensions.

Aspect 15: The device of any aspects 1 through 14, wherein the asymmetric operations include the use of asymmetric depth-to-space operations in a disparity width dimension, wherein a larger rate through multiplication in the disparity width dimension is used than in other non-disparity dimensions.

Aspect 16: The device of any aspects 1 through 15, wherein the plurality of cameras include a left camera and a right camera, wherein, the left camera is configured to capture the left image and right camera is configured to capture the right image, and the one or more processors are configured to generate both the first down-sample and the second down-sample from the left and right image, respectively.

Aspect 17: A method for providing a stereo image, the method comprising: capturing one or more images, wherein each of the images includes one or more patches, each patch including plurality of pixels; down-sampling in a first direction on a first set of pixels in a first patch of a first image to generate a first down-sample; and down-sampling in a second direction on a second set of pixels in a second patch of a second image to generate a second down-sample, wherein, the second down-sample includes a greater number of pixels.

Aspect 18: The method of aspect 17, wherein the first down-sample in the first direction is in height and the second down-sample in the second direction is in width, such that, the first and second down-sample is an asymmetric down-sample operation that includes a higher resolution in width.

Aspect 19: The method of aspect 18, wherein, multiple asymmetric down-sample operations are performed in a down-sampling process, each asymmetric down-sample operation including a width-to-height aspect ratio.

Aspect 20: A non-transitory computer-readable data storage medium having stored thereon instructions that, when executed, cause one or more processors to: capture one or more images, wherein each of the images includes one or more patches, each patch including plurality of pixels; down-sample in a first direction on a first set of pixels in a first patch of a first image to generate a first down-sample; and down-sample in a second direction on a second set of pixels in a second patch of a second image to generate a second down-sample, wherein, the second down-sample includes a greater number of pixels.

This disclosure describes one or more examples that may be applied independently or in a combined way. It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

One or more of the components, steps, features and/or functions illustrated in FIGS. 1-8 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-8 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

Various examples have been described. These and other examples are within the scope of the following claims.

What is claimed is:

1. A device comprising:
one or more memories configured to store a plurality of images;
a plurality of cameras configured to capture a left and right image, wherein each of the images includes one or more patches, each patch including plurality of pixels; and
one or more processors coupled to the one or memories, the one or more processors are configured to:
down-sample in a first direction on a first set of pixels in a first patch of a first image to generate a first down-sample; and
down-sample in a second direction on a second set of pixels in a second patch of a second image to generate a second down-sample, wherein, the second down-sample includes a greater number of pixels.

2. The device of claim 1, wherein the first down-sample in the first direction is in height and the second down-sample in the second direction is in width, such that, the first and second down-sample is an asymmetric down-sample operation that includes a higher resolution in width.

3. The device of claim 2, wherein, multiple asymmetric down-sample operations are performed in a down-sampling process, each asymmetric down-sample operation including a width-to-height aspect ratio.

4. The device of claim 3, wherein the multiple width-to-height aspect ratios are equal or increasing or decreasing during the down-sampling process.

5. The device of claim 3, further comprising performing depth estimation in the down-sampling process.

6. The device of claim 3, wherein, the one or more processors are configured to perform an up-sampling process.

7. The device of claim 3, wherein, the one or more processors are configured to:
render the output of the down-sampling process for the left and right images; and
combine the left and right rendered images to generate a stereo image output.

8. The device of claim 7, wherein, the down-sampling process further comprises implementing a multi-aspect ratio method for estimating stereo disparity.

9. The device of claim 8, wherein, based upon the implementation of the multi-aspect ratio method for estimating stereo disparity in the down-sampling process, the stereo image output rendered by the down-sampling process includes stereo depth map resolution replicating original stereo depth map resolution associated with the original stereo image.

10. The device of claim 7, further comprising a display device, wherein, the one or more processors are configured to command the display of the stereo image output on the display device.

11. The device of claim 5, further comprising a modem configured to transmit output from the down-sampling process to another device.

12. The device of claim 5, wherein, the one or more processors are further configured to: implement a machine learning model including down-sampling stages to implement the down-sampling process.

13. The device of claim 12, wherein, the machine learning model is a neural network.

14. The device of claim 2, wherein the asymmetric operations include the use of asymmetric space-to-depth operations in a disparity width dimension, wherein a smaller rate through division in the disparity width dimension is used than in other non-disparity dimensions.

15. The device of claim 2, wherein the asymmetric operations include the use of asymmetric depth-to-space operations in a disparity width dimension, wherein a larger rate through multiplication in the disparity width dimension is used than in other non-disparity dimensions.

16. The device of claim 2, wherein the plurality of cameras include a left camera and a right camera, wherein, the left camera is configured to capture the left image and right camera is configured to capture the right image, and the one or more processors are configured to generate both the first down-sample and the second down-sample from the left and right image, respectively.

17. A method for providing a stereo image, the method comprising:
capturing one or more images, wherein each of the images includes one or more patches, each patch including plurality of pixels;
down-sampling in a first direction on a first set of pixels in a first patch of a first image to generate a first down-sample; and
down-sampling in a second direction on a second set of pixels in a second patch of a second image to generate a second down-sample, wherein, the second down-sample includes a greater number of pixels.

18. The method of claim 17, wherein the first down-sample in the first direction is in height and the second down-sample in the second direction is in width, such that, the first and second down-sample is an asymmetric down-sample operation that includes a higher resolution in width.

19. The method of claim 18, wherein, multiple asymmetric down-sample operations are performed in a down-sampling process, each asymmetric down-sample operation including a width-to-height aspect ratio.

20. A non-transitory computer-readable data storage medium having stored thereon instructions that, when executed, cause one or more processors to:
capture one or more images, wherein each of the images includes one or more patches, each patch including plurality of pixels;
down-sample in a first direction on a first set of pixels in a first patch of a first image to generate a first down-sample; and
down-sample in a second direction on a second set of pixels in a second patch of a second image to generate a second down-sample, wherein, the second down-sample includes a greater number of pixels.
